(19) United States
(12) Patent Application Publication
(10) Pub. No.: US 2017/0109672 A1
(43) Pub. Date: Apr. 20, 2017

(54) SYSTEMS, DEVICES, AND METHODS FOR GENERATING AND RENDERING SNOW REMOVAL PROCESS DATA

(71) Applicant: Wal-Mart Stores, Inc., Bentonville, AR (US)

(72) Inventors: Madhur Sarin, Bangalore (IN); Willie Montgomery, III, Rogers, AR (US)

(21) Appl. No.: 14/956,136

(22) Filed: Dec. 1, 2015

(30) Foreign Application Priority Data
Oct. 16, 2015 (IN) 3334/DEL/2015

(51) Int. Cl. G06Q 10/06

(52) U.S. Cl. CPC G06Q 10/06313

(57) ABSTRACT

Provided herein are methodologies, systems, apparatus, and non-transitory computer-readable media for controlling a graphical user interface of an electronic display device to display a snow removal process type recommendation and a snow removal process value recommendation. A snow removal process recommendation tool can consider various store attributes, historical weather data, and other factors to compute a process type and process value recommendation for a selected store. A number of comparable stores, or sister-stores, can be computed based the stores which are most similar to the selected store in parking lot size, transaction volume, metadata, and other attributes. The snow removal process type recommendation and snow removal process value recommendation can be determined based on historical process data corresponding to these comparable stores.

### RELATED APPLICATIONS

This application claims benefit of and priority to Indian Patent Application No. 3334/DEL/2015, tiled Oct. 16, 2015, which is incorporated herein by reference in its entirety.

### BACKGROUND OF THE TECHNOLOGY

In general, snow removal contracts that are entered into by an enterprise may be event-based contracts or seasonal contracts. Certain existing techniques allow store managers to receive bids from snow removal contractors.

### SUMMARY

Exemplary embodiments of the present disclosure provide systems, devices, and methods for configuring a graphical user interface of an electronic display device to facilitate displaying snow removal process recommendations.

In accordance with some examples of the present disclosure, a method of controlling a graphical user interface of an electronic display device is disclosed to facilitate displaying snow removal process recommendations in response to a computational analysis of attribute data, regional climate data, and historical contract data received from one or more external servers. The method includes receiving, in an electronic computer-readable format, attribute data corresponding to attributes associated with a plurality of stores. The method also includes receiving, in an electronic computer-readable format, regional climate data corresponding to the regional climate of each of the plurality of stores. The method also includes receiving from a user store identification information identifying a specific store from the plurality of stores. The method also includes computing, using a store comparison module, a list of comparable stores from the plurality of stores, each of the comparable stores classified as having store attributes and regional climates similar to the specific store based on a computational analysis of the attribute data and regional climate data. The method also includes receiving, in an electronic computer-readable format from one or more servers associated with each of the comparable stores, data corresponding to historical snow removal process values and historical snow removal process types for each of the comparable stores. The method also includes computing, using a process type recommendation module, a snow removal process type recommendation for the specific store based on a computational analysis of the historical snow removal process types of the comparable stores. The method also includes computing, using a process value recommendation module, a snow removal process value recommendation for the specific store based on a computational analysis of the historical snow removal process value of the comparable stores. The snow removal process type recommendation and snow removal process value recommendation can also be computed based on any one or more of a market average, a predetermined percent decrease in snow removal process value, or a single normalized store that is most similar to the selected store. The method also includes rendering, on an electronic display device, a graphical user interface, the graphical user interface comprising a graphical indication of the snow removal process type recommendation and the snow removal process value recommendation for the specific store. In some examples, the store attribute data includes historical data corresponding to past process values, past process types, or past process providers. In some examples, the store attribute data includes data corresponding to any one or more of a store's transaction volume, operating hours, geographical coordinates, region, population density, parking lot area, city, urbanicity (i.e., whether a store is in an urban, suburban, or rural area), store format (e.g., discount stores, supermarkets, warehouse stores, supercenters, etc.), store market (i.e., a grouping of a number of stores within a specific region), or whether a first store shares a parking lot with another store. In some examples, the regional climate data includes statistical data corresponding to rainfall, temperature, snowfall depth, snowfall frequency. In some examples, the graphical user interface further includes identification information corresponding to a snow removal contractor. In some examples, the graphical user interface further includes a graphical indication of historical snow removal process values and historical snow removal process types for each of the comparable stores. In some examples the graphical indications of historical snow removal process values and historical snow removal process types for each of the comparable stores are sorted by proximity to the specific store. In some examples, the graphical user interface is also programmed to receive a distance radius, and each of the comparable stores is within the distance radius of the specific store. In some examples, the graphical user interface further includes a graph indicative of the regional climate data, store attribute data, historical snow removal process values, or historical snow removal process types for at least one of the comparable stores. In some examples, the method includes computing a single comparable store having store attribute data and regional climate data most similar to the selected store.

Any combination or permutation of the above examples is envisioned. It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

The foregoing and other features and advantages provided by the present disclosure will be more fully understood from the following description of exemplary embodiments when read together with the accompanying drawings, in which:

FIG. 1 is a flowchart illustrating an exemplary method of configuring a graphical user interface of an electronic display device, according to embodiments of the present disclosure.

FIG. 2 is a flowchart illustrating another exemplary method of configuring a graphical user interface of an electronic display device, according to embodiments of the present disclosure.

FIG. 3 depicts an exemplary graphical user interface for displaying snow removal contract recommendations, according to embodiments of the present disclosure.

FIG. 4 depicts another exemplary graphical user interface for displaying snow removal contract recommendations, according to embodiments of the present disclosure.

FIG. 5 is a diagram of an exemplary network environment suitable for a distributed implementation of exemplary embodiments of the present disclosure.

FIG. 6 is a block diagram of an exemplary computing device that can be used to perform exemplary processes in accordance with exemplary embodiments of the present disclosure.

### DETAILED DESCRIPTION

Following below are more detailed descriptions of various concepts related to, and embodiments of, inventive methods, apparatus, and systems for configuring a graphical user interface of an electronic display device to facilitate calculating and displaying snow removal contract recommendations. It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

As used herein, the term “includes” means includes but is not limited to, the term “including” means including but not limited to. The term “based on” means based at least in part on.

Example methodologies, systems, apparatus, and non-transitory computer-readable media are described herein to facilitate generating snow removal contract recommendations and configuring a graphical user interface of an electronic display device to facilitate displaying the snow removal contract recommendations. According to some examples, prior to each snow season, store managers can contact snow removal contractors in order to select either a seasonal or event-based contract and negotiate a price. In a seasonal contract, the store pays a single price for an entire year's worth of snow removal services, while in an event-based contract, the store pays for snow removal services based on the number of snow storms that occur. In areas where there is both high frequency and high depth of snowfall, generally a seasonal contract is preferred, while event based contracts are generally preferred in areas where there is low frequency and low depth of snowfall. The techniques disclosed herein can provide a recommendation on the type of contract that a store should select, as well as how much that contract should cost. These recommendations are based on multiple store characteristics, regional climate data, and a comparison of various stores against each other.

In one example, a store manager can input a store number and a distance radius for snow removal contractors. The snow removal contract recommendation tool disclosed herein can consider various store attributes, historical weather data, and other factors to provide a contract type and contract price recommendation. As described herein, a snow removal contract relates to a snow removal process or service performed by a snow removal contractor. Similarly, a snow removal contract price or snow removal contract price recommendation relates to an actual or recommended value associated with the snow removal process or snow removal service. A list of comparable stores, or sister-stores, that share various attributes with the selected store, can be generated, and the snow removal contract recommendations can be determined based on historical contract data corresponding to the comparable stores. In one example, the comparable stores are those stores within the distance radius that have the most similar parking lot sizes and/or similar transaction volume. Various store attributes may include, for example, parking lot square footage, store transaction volume (which measures the difficulty of cleaning the lot due to the number of customers using the parking lot), store operating hours, market performance, latitude and longitude information, population density, city, urbanicity, store format, store market, whether the store shares a parking lot with another store, etc. Various types of metadata and climate data may include, for example, statistical data relating to rainfall, temperature, snowfall depth, snowfall frequency, etc. In some examples a user can adjust the distance radius in order to update the area used to calculate the list of comparable stores, as well as the list of snow removal contractors or vendors.

In some examples, the snow removal recommendation tool may be displayed via a GUI and can be used by a store manager to select a particular store and view a contract type recommendation and a contract price recommendation. The snow removal recommendation tool can also display the contract type and price for the previous year's snow removal contract, the prices paid by comparable stores, the contract type selected by comparable stores, and snow removal contractor/vendor information. In other examples, the snow removal recommendation tool may include more detailed information regarding the selected store, a comparison of the selected store against the comparable stores based on various characteristics, a ranking of the closest matches among the comparable stores, and various graphs or charts comparing store attributes and climate statistics among the comparable stores. The snow removal contract recommendation tool can also allow a user to select a desired distance radius in an area of interest, in order to view and compare comparable stores, along with their corresponding attributes, within the selected distance radius.

Exemplary embodiments are described below with reference to the drawings. One of ordinary skill in the art will recognize that exemplary embodiments are not limited to the illustrative embodiments, and that components of exemplary systems, devices and methods are not limited to the illustrative embodiments described below.

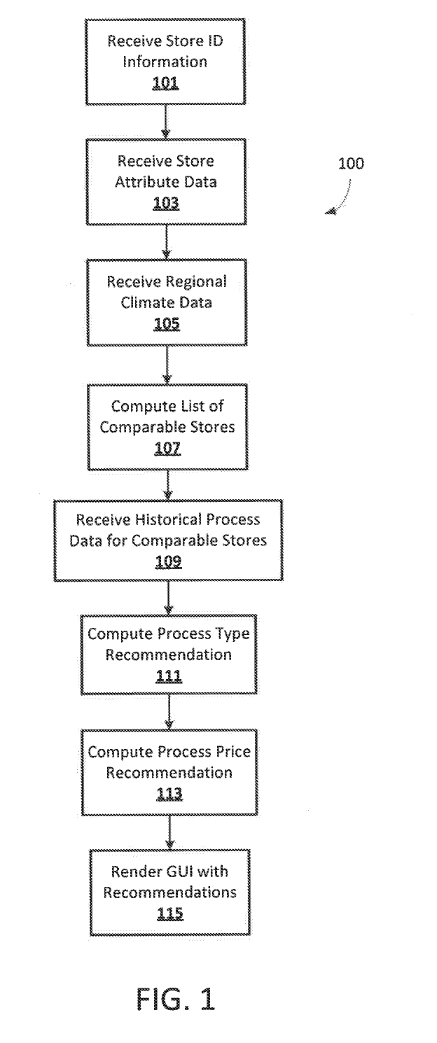

FIG. 1 is a flowchart illustrating an example method 100 for configuring a graphical user interface of an electronic display device, according to embodiments of the present disclosure. In step 101, store identification information is received from a user, which identifies a selected store from a plurality of stores. The store identification information may include, for example, an enterprise-assigned store number. This information identifies the specific store for which snow removal contract or process recommendations will be computed.

In step 103, a server receives attribute data, in an electronic computer-readable format, associated with a plurality of stores. The attribute data can include, for example, historical data corresponding to past contract prices, past contract types, or past contract providers. In other examples, the store attribute data includes data corresponding to a store's transaction volume, operating hours, geographical coordinates, region, population density, parking lot area, city, urbanicity, store format, store market, or whether the store shares a parking lot with another store.

In step 105, a server receives regional climate data, in an electronic computer-readable format, corresponding to the regional climate of each of the plurality of stores. In some examples, the regional climate data includes statistical data corresponding to rainfall, temperatures, snowfall depth, or snowfall frequency.

In step 107, a list of comparable stores is computed using a store comparison module. Each of the comparable stores is selected from the plurality of stores and classified as having store attributes and regional climates similar to the store selected above in step 101. In some examples, the comparable stores can be computed using a machine learning tool or predictive modeling techniques. In an example, the machine learning tool can be a supervised learning tool, such as but not limited to tool based on at least one of a decision tree, an ensemble (bagging, boosting, or random forest), k-nearest neighbor (k-NN), a linear regression, naive Bayes, a neural network, a support vector machine (SVM), or a relevance vector machine (RVM). In an example, the machine learning tool can be an unsupervised learning tool, such as but not limited to tool based on at least one of hierarchical clustering or k-means clustering.

In step 109, a server receives historical snow removal contract data, in an electronic computer-readable format, corresponding to each of the comparable stores. The historical snow removal contract data corresponds to the snow removal contract types and snow removal contract prices for the comparable stores.

In step 111, a snow removal contract type recommendation is computed, using a contract type recommendation module, for the specific store selected in step 101. The snow removal contract type recommendation is computed based on the historical snow removal contract types of the comparable stores calculated in step 107.

In step 113, a snow removal contract price recommendation is computed, using a contract price recommendation module, for the specific store selected in step 101. The snow removal contract price recommendation is computed based on the historical snow removal contract prices of the comparable stores calculated in step 107.

In step 115, a GUI is rendered on an electronic display device. The GUI includes a graphical indication of the snow removal contract type recommendation computed in step 111 and a graphical indication of the snow removal contract price recommendation computed in step 113. In some examples, the GUI also includes identification information corresponding to snow removal contractors. The identification information can include the contractor's name, a contact name, and the contractor's contact information. In some examples, the GUI includes a listing of historical snow removal contract prices and historical snow removal contract types for each of the comparable stores. In some examples, this listing may be sorted by proximity to the selected store. This can allow a store manager to contact multiple contractors and negotiate a price.

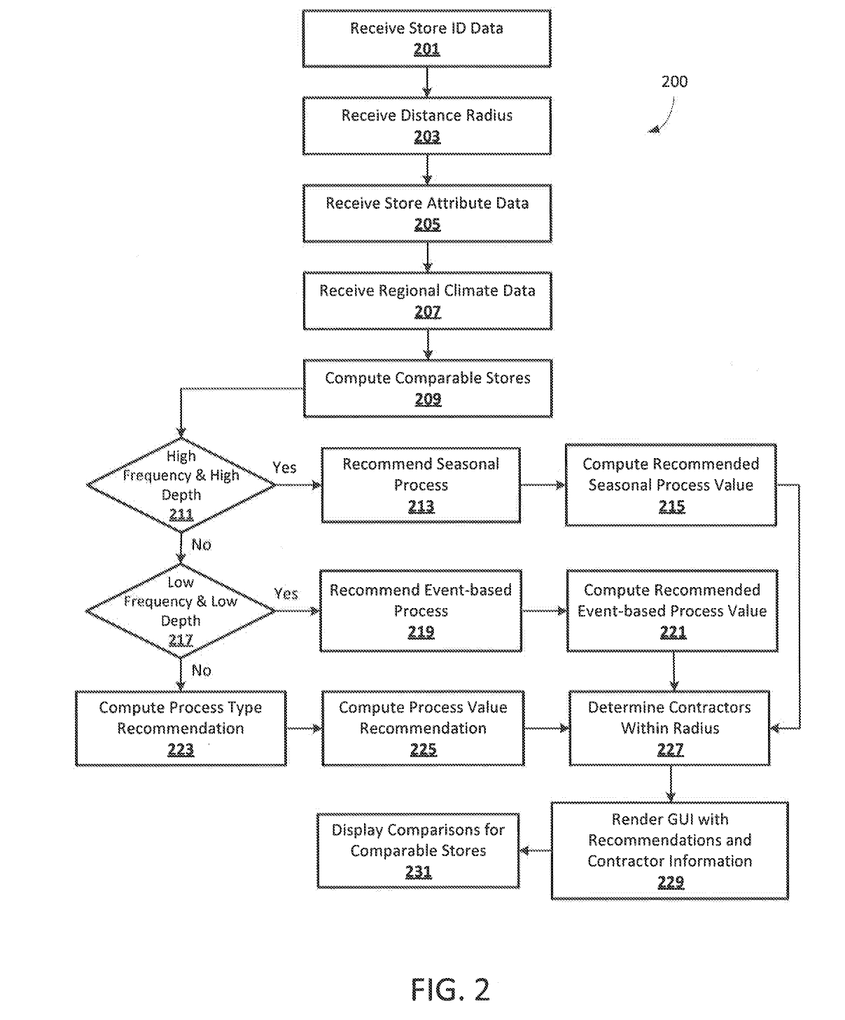

FIG. 2 is a flowchart illustrating another example method 200 for configuring a graphical user interface of an electronic display device, according to embodiments of the present disclosure. In step 201, store identification information is received from a user, which identifies a selected store from a plurality of stores. The store identification information may include, for example, an enterprise-assigned store number. This information identifies the specific store for which snow removal contract recommendations will be computed.

In step 203, a distance radius is received, which is used to determine the geographical area for computing comparable stores, as well as generate lists of snow removal contractors, in some examples. In some examples, the distance radius can be updated by the user, via the GUI, in order to update the comparable stores and the contract recommendations.

In step 205, a server receives attribute data, in an electronic computer-readable format, associated with a plurality of stores. The attribute data can include, for example, historical data corresponding to past contract prices, past contract types, or past contract providers. In other examples, the store attribute data includes data corresponding to a store's transaction volume, operating hours, geographical coordinates, region, population density, parking lot area, city, urbanicity, store format, store market, or whether the store shares a parking lot with another store.

In step 207, a server receives regional climate data, in an electronic computer-readable format, corresponding to the regional climate of each of the plurality of stores. In some examples, the regional climate data includes statistical data corresponding to rainfall, temperatures, snowfall depth, or snowfall frequency.

In step 209, a list of comparable stores is computed using a store comparison module. Each of the comparable stores is selected from the plurality of stores and classified as having store attributes and regional climates similar to the store selected above in step 201. In some examples, the comparable stores can be computed using a machine learning tool or predictive modeling techniques, including any of the example learning tools described herein.

In step 211, the method determines whether the store selected in step 201 is in an area which receives high snowfall frequency and high snowfall depth. If it is determined in step 211 that the selected store has high snowfall frequency and high snowfall depth, a seasonal-type contract is recommended in step 213. This recommendation is based on the statistical knowledge that seasonal snow removal contracts are best in areas of high snowfall frequency and high snowfall depth. Once the seasonal contract is recommended, a recommended seasonal contract price is computed in step 215. The recommended seasonal contract price can be computed based on historical contract prices for the list of comparable stores computed in step 209.

If it is determined in step 211 that the selected store does not have high snowfall frequency and high snowfall depth, the method determines in step 217 whether the selected store has low snowfall frequency and low snowfall depth. If it is determined in step 217 that the selected store has low snowfall frequency and low snowfall depth, an event-based contract is recommended in step 219. This recommendation is based on the statistical knowledge that event-based contracts are best in areas of low snowfall frequency and low snowfall depth. Once the event-based contract recommendation is computed, a recommended event-based contract price is computed in step 221. The recommended event-based contract price can be computed based on historical contract prices for the list of comparable stores computed in step 209. The snow removal contract price recommendation can also be computed based on a market average, a predetermined percent decrease in snow removal contract price, or a single normalized store that is most similar to the selected store.

If it is determined in step 217 that the selected store does not have low snowfall frequency and low snowfall depth, then the contract type recommendation is computed in step 223. The contract type recommendation is computed based on historical contract types for the comparable stores computed in step 209. Once the snow removal contract type recommendation has been computed in step 223, a recommended snow removal contract price is computed in step 225. The recommended snow removal contract price is computed based on historical contract prices for the comparable stores computed in step 209.

Once a snow removal contract price has been computed in steps 215, 221, or 225, a list of snow removal contractors can be determined in step 227. The snow removal contractors can include contractors within the distance radius selected in step 203.

In step 229, a GUI is rendered on an electronic display device. The GUI includes a graphical indication of the snow removal contract type recommendation computed in step 213, 219, or 223 and a graphical indication of the snow removal contract price recommendation computed in step 215, 221, or 225. In some examples, the GUI also includes identification information corresponding to snow removal contractors. The identification information can include the contractor's name, a contact name, and the contractor's contact information.

In step 231, the GUI displays comparisons between the various comparable stores computed in step 209 and the specific store selected in step 201. In some examples, the comparisons include graphs or charts indicating regional climate data, store attribute data, historical snow removal contract prices, historical snow removal contract types, geographic coordinate information, precipitation levels, average temperatures, etc. corresponding to the store selected in step 201 and the comparable stores computed in step 209.

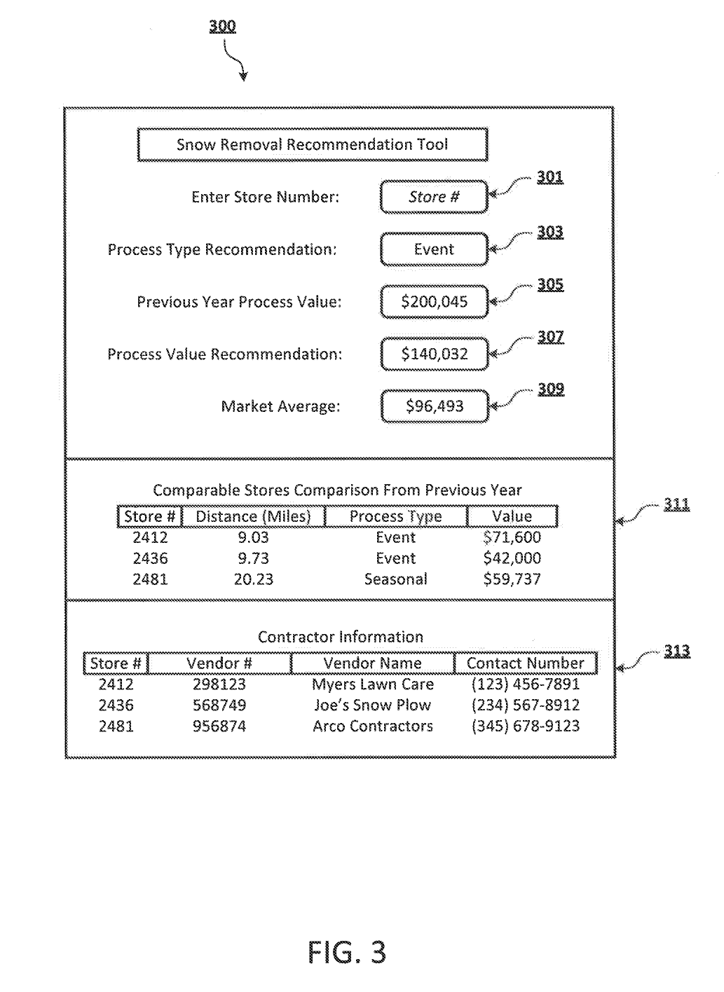

FIG. 3 depicts an exemplary graphical user interface 300 for rendering a snow removal contract recommendation tool, according to embodiments of the present disclosure. As shown in this particular example, the GUI can be configured to allow a user to enter store identification information, such as a store ID number 301. Once the store ID number has been entered, the contract type recommendation 303 is computed, as discussed above, and rendered via the GUI. The GUI can also include a graphical indication of the previous year's contract price 305, the computed contract price recommendation 307, and the market average price 309. In sonic examples, the GUI can display a comparison 311 of the contract types and contract prices of the comparable stores from the previous year. In this particular example, three comparable stores are shown, sorted based on proximity to the selected store, along with their contract type and contract price from the previous year. The GUI can also display a listing 313 of various snow removal contractors, along with their contact information such as a contact name, phone number, email address, etc. In some examples, the contractors may include snow removal contractors previously used by the selected store or comparable stores.

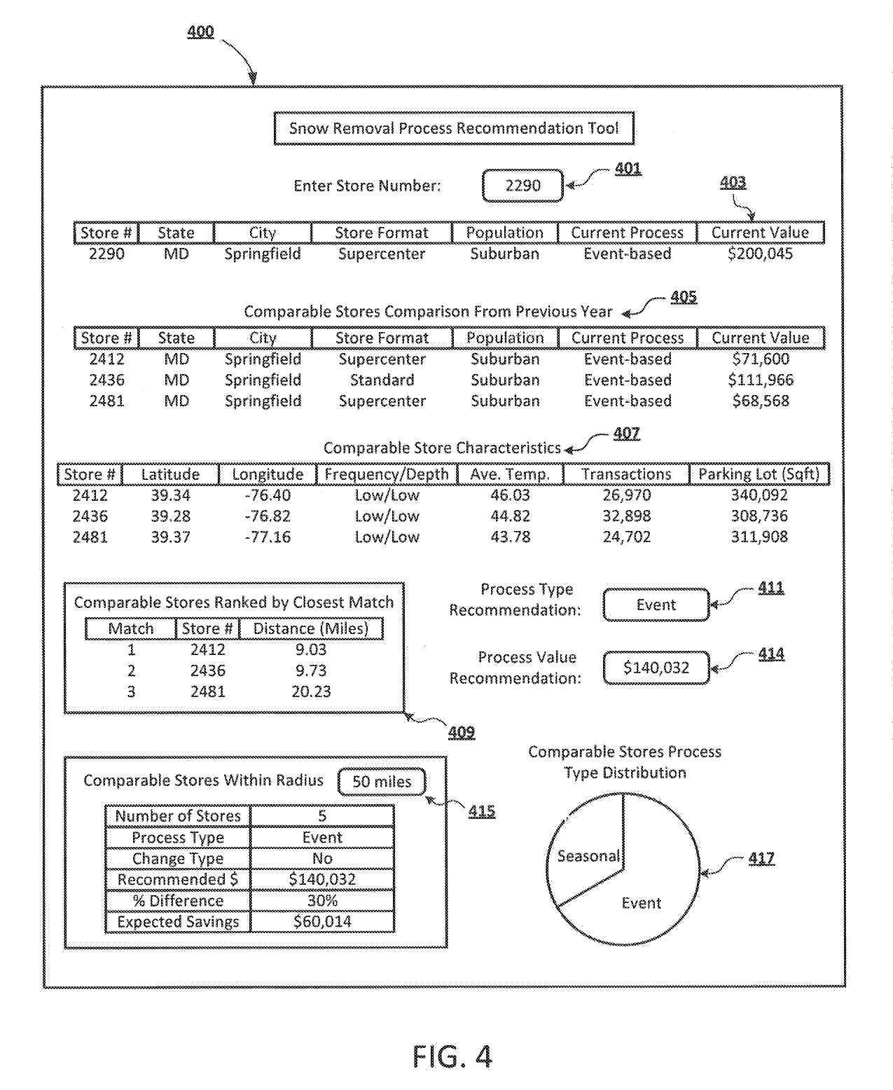

FIG. 4 depicts another exemplary graphical user interface 400 for rendering a snow removal contract recommendation tool, according to embodiments of the present disclosure. As shown in this particular example, the GUI can display more detailed information and comparisons between stores, as compared to the GUI illustrated in FIG. 3. This more detailed comparison allows a user to view store attribute data, regional climate data, and historical snow removal contract information corresponding to a number of comparable stores, alongside the snow removal contract type and snow removal contract price recommendations. The GUI 400 can allow a user to enter store identification information, such as a store ID number 401. Once a store ID number has been entered, the GUI can display a more detailed description 403 of the selected store. The store description 403 may include the selected store's city and state, whether the store is a standard-format store or a lager “supercenter” style store, an indication of whether the store is in an urban or suburban population, whether the store most recently had an event-based or seasonal snow removal contract, as well as the cost of the store's most recent snow removal contract. The GUI can also include a detailed description 405 of the previous year's snow removal contract data from the most comparable stores to the selected store. This allows a user to easily view and compare contract types and prices from comparable stores. In some examples, the GUI can include a detailed description 407 of various characteristics of the most comparable stores. This description can include latitude and longitude information, snowfall frequency and snowfall depth, average seasonal temperatures, transaction volume, and parking lot square footage. The GUI can also include a listing 409 of the comparable stores ranked based on the closest match to the selected store. In this way, a user can identify the store having the most similar attributes to the selected store. The GUI can also include a graphical indication of the contract type recommendation 411 and the contract price recommendation 414 for the selected store. As discussed above, the contract type recommendation and the contract price recommendation can be determined based on the historical contract data corresponding to the stores which are most comparable to the selected store.

In some examples, the GUI 400 can allow a user to input a distance radius 415 and view a summary of comparable stores within that radius. In this particular example, there are five comparable stores within the selected radius. Based on the data corresponding to these comparable stores, an event-based contract is recommended, which means that no change in contract type should be required. The recommended price is determined to be $140,032, which is a 30% decrease over the previous year and would result in expected savings of $60,014. In this particular example, the GUI also includes a pie chart 417 showing the distribution of contract types between the comparable stores. In other examples, the GUI can include additional graphs or charts comparing climate data, precipitation data, temperature data, latitude and longitude data, transaction volume, parking lot area, etc. between the selected store and the comparable stores. As will be appreciated, the snow removal contract type recommendation and the snow removal contract price recommendation may be computed in a number of ways. For example, the recommendations can be computed based on a market average or an average of contract types or contract prices for comparable stores. In other exemplary embodiments, the recommendations can be computed based on the historical contract types and/or historical contract prices corresponding to a comparable store that has the most similar parking lot size, most similar transaction volume, is the closest geographically to the selected store, or is otherwise similar to the selected store based on store attributes and/or regional climate. The contract price recommendation can be computed, in other examples, as an average of the prices historically paid by the top five or ten most comparable stores. Similarly, the contract type recommendation can be computed based on the average contract type selected by the top five or ten most comparable stores. As discussed above, comparable stores may be computed based on proximity, similarity in climate, similarity in parking lot size, similarity in transaction volume, etc.

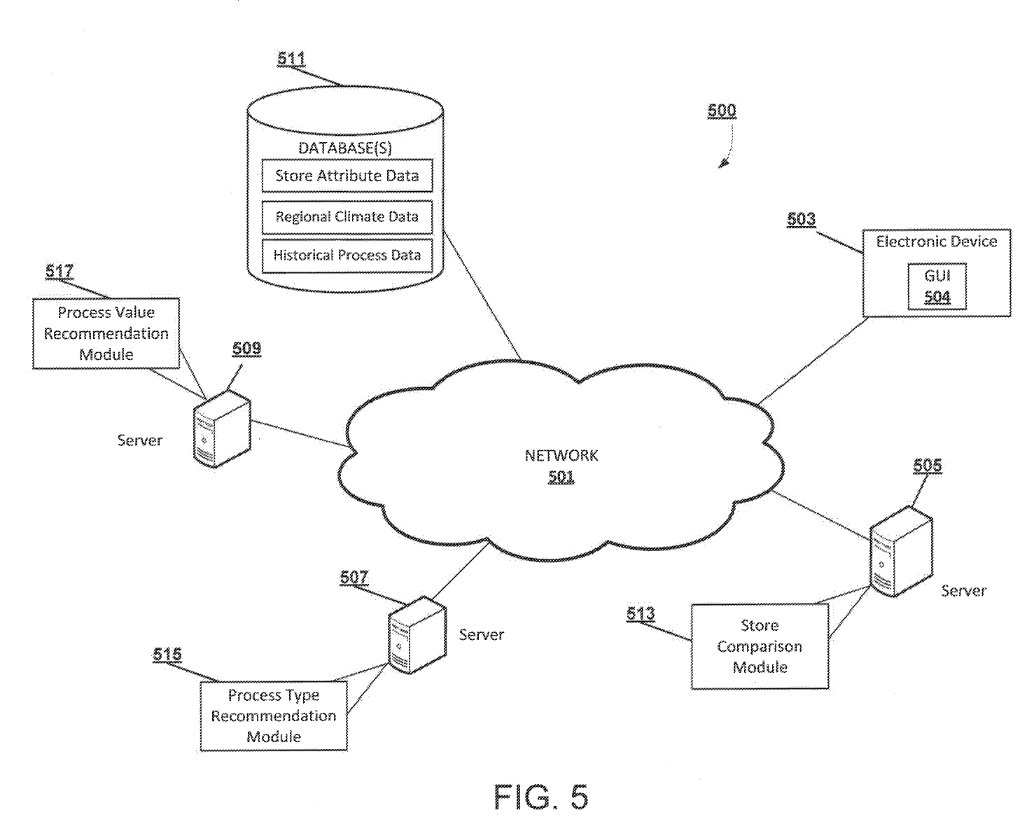

FIG. 5 is a diagram of an exemplary network environment 500 suitable for a distributed implementation of exemplary embodiments. The network environment 500 can include one or more servers 505, 507, and 509. As will be appreciated, various distributed or centralized configurations may be implemented, and in some embodiments a single server can be used. The network environment may also include a database 511, associated with servers 505, 507, and 509. In exemplary embodiments, the database 511 can store the various store attribute data, regional climate data, and historical contract data, while the one or more servers 505, 507, and 509 can store a store comparison module 513, contract type recommendation module 515, and/or contract price recommendation module 517, which can implement one or more of the processes described herein with respect to FIGS. 1 and 2. The network environment may also include an electronic device 503, that may display a GUI 504 to a user as described above in reference to FIGS. 3-4. Once the electronic device 503 receives instructions from the one or more servers 505, 507, and 509, the GUI 504 may be rendered on the electronic device 503 to allow a user to interact with the servers to implement embodiments of the snow removal contract recommendation tool.

In exemplary embodiments, the servers 505, 507, and 509, database 511, and the electronic device 503 may be in communication with each other via a communication network 501. The communication network 501 may include, but is not limited to, the Internet, an intranet, a LAN (Local Area Network), a WAN (Wide Area Network), a MAN (Metropolitan Area Network), a wireless network, an optical network, and the like. In exemplary embodiments, the electronic device 503 that is in communication with the servers 505, 507, and 509 and database 511 can generate and transmit a database query requesting information from the raw data matrices or database 511. The one or more servers 505, 507, and 509 can transmit instructions to the electronic device 503 over the communication network 501.

In exemplary embodiments, the store attribute data, regional climate data, historical snow removal contract data, etc. can be stored at database 511 and received at the one or more servers 505, 507, and 509 in order to compute the list of comparable stores, the snow removal contract type recommendation, and the snow removal contract price recommendation. The servers 505, 507, and 509 can interact with the electronic device 503 and database 511 over communication network 501 to render the GUI 504, as described above in reference to FIGS. 3-4.

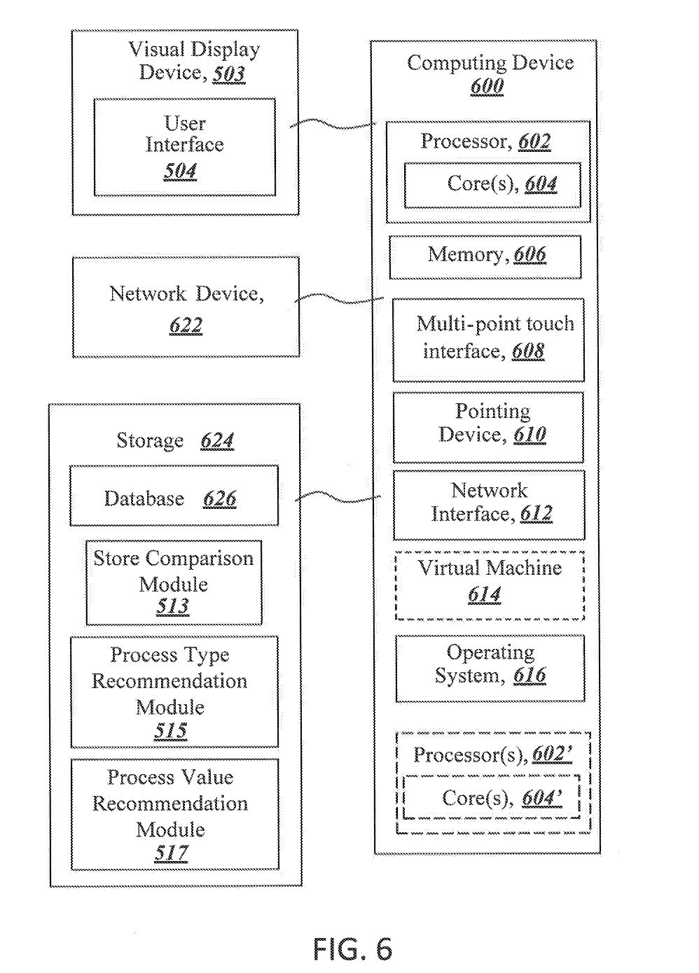

FIG. 6 is a block diagram of an exemplary computing device 600 that can be used in the performance of any of the example methods according to the principles described herein. The computing device 600 includes one or more non-transitory computer-readable media for storing one or more computer-executable instructions (such as but not limited to software or firmware) for implementing any example method according to the principles described herein. The non-transitory computer-readable media can include, but are not limited to, one or more types of hardware memory, non-transitory tangible media (for example, one or more magnetic storage disks, one or more optical disks, one or more USB flashdrives), and the like. For example, memory 606 included in the computing device 600 can store computer- readable and computer-executable instructions or software for implementing exemplary embodiments, such as a store comparison module 513, contract type recommendation module 515, and/or contract price recommendation module 517 associated with embodiments of the snow removal contract recommendation tool and programmed to perform processes described herein. The computing device 600 also includes processor 602 and associated core 604, and optionally, one or more additional processor(s) 602′ and associated core(s) 604′ (for example, in the case of computer systems having multiple processors/cores), for executing computer-readable and computer-executable instructions or software stored in the memory 606 and other programs for controlling system hardware. Processor 602 and processor(s) 602′ can each be a single core processor or multiple core (604 and 604′) processor.

Virtualization can be employed in the computing device 600 so that infrastructure and resources in the computing device can be shared dynamically. A virtual machine 614 can be provided to handle a process running on multiple processors so that the process appears to be using only one computing resource rather than multiple computing resources. Multiple virtual machines can also be used with one processor.

Memory 606 can be non-transitory computer-readable media including a computer system memory or random access memory, such as DRAM, SRAM, EDO RAM, and the like. Memory 606 can include other types of memory as well, or combinations thereof.

A user can interact with the computing device 600 through a visual display device 503, such as a touch screen display or computer monitor, which can display one or more user interfaces 504 that can be provided in accordance with exemplary embodiments, for example, the exemplary interfaces illustrated in FIGS. 3-4. The computing device 600 can include other I/O devices for receiving input from a user, for example, a keyboard or any suitable multi-point touch interface 608, a pointing device 610 (e.g., a pen, stylus, mouse, or trackpad). The keyboard 608 and the pointing device 610 can be coupled to the visual display device 503. The computing device 600 can include other suitable conventional I/O peripherals.

The computing device 600 can also include one or more storage devices 624, such as a hard-drive, CD-ROM, or other non-transitory computer readable media, for storing data and computer-readable instructions and/or software, such as the store comparison module 513, contract type recommendation module 515, and the contract price recommendation module 517, which may generate user interface 504 that implements exemplary embodiments of the methods and systems as taught herein, or portions thereof. Exemplary storage device 624 can also store one or more databases 626 for storing any suitable information required to implement exemplary embodiments. The databases can be updated by a user or automatically at any suitable time to add, delete or update one or more items in the databases. Exemplary storage device 624 can store one or more databases 626 for storing store attribute data, regional climate data, historical snow removal contract data, and any other data/information used to implement exemplary embodiments of the systems and methods described herein.

The computing device 600 can include a network interface 612 configured to interface via one or more network devices 622 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. The network interface 612 can include a built-in network adapter, network interface card, PCMCIA network card, card bus network adapter, wireless network adapter, USB network adapter, modem or any other device suitable for interfacing the computing device 600 to any type of network capable of communication and performing the operations described herein. Moreover, the computing device 600 can be any computer system, such as a workstation, desktop computer, server, laptop, handheld computer, tablet computer (e.g., the iPad® tablet computer), mobile computing or communication device (e.g., the iPhone® communication device), or other form of computing or telecommunications device that is capable of communication and that has sufficient processor power and memory capacity to perform the operations described herein.

The computing device 600 can run any operating system 616, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, any operating systems for mobile computing devices, or any other operating system capable of running on the computing device and performing the operations described herein. In exemplary embodiments, the operating system 616 can be run in native mode or emulated mode. In an exemplary embodiment, the operating system 616 can be run on one or more cloud machine instances

In describing example embodiments, specific terminology is used for the sake of clarity. For purposes of description, each specific term is intended to at least include all technical and functional equivalents that operate in a similar manner to accomplish a similar purpose. Additionally, in some instances where a particular example embodiment includes a plurality of system elements, device components or method steps, those elements, components or steps can be replaced with a single element, component or step. Likewise, a single element, component or step can be replaced with a plurality of elements, components or steps that serve the same purpose. Moreover, while example embodiments have been shown and described with references to particular embodiments thereof, those of ordinary skill in the art will understand that various substitutions and alterations in form and detail can be made therein without departing from the scope of the invention. Further still, other aspects, functions and advantages are also within the scope of the invention.

Example flowcharts are provided herein for illustrative purposes and are non-limiting examples of methods. One of ordinary skill in the art will recognize that example methods can include more or fewer steps than those illustrated in the example flowcharts, and that the steps in the example flowcharts can be performed in a different order than the order shown in the illustrative flowcharts.

What is claimed is:

1. A method for controlling a graphical user interface of an electronic display device in response to a computational analysis of attribute data, regional climate data, and historical process data received from one or more external servers, the method comprising:
receiving, in an electronic computer-readable format, attribute data corresponding to attributes associated with a plurality of stores;
receiving, in an electronic computer-readable format, regional climate data corresponding to the regional climate of each of the plurality of stores;
receiving from a user store identification information identifying a specific store from the plurality of stores;
computing, using a store comparison module, a list of comparable stores from the plurality of stores, each of the comparable stores classified as having store attributes and regional climates similar to the specific store based on a computational analysis of the attribute data and regional climate data;
receiving, in an electronic computer-readable format from one or more servers associated with each of the comparable stores, data corresponding to historical snow removal process values and historical snow removal process types for each of the comparable stores;
computing, using a process type recommendation module, a snow removal process type recommendation for the specific store based on a computational analysis of the historical snow removal process types of the comparable stores;
computing, using a process value recommendation module, a snow removal process value recommendation for the specific store based on a computational analysis of the historical snow removal process values of the comparable stores; and
rendering, on an electronic display device, a graphical user interface, the graphical user interface comprising a graphical indication of the snow removal process type recommendation and the snow removal process value recommendation for the specific store.

2. The method of claim 1, wherein the store attribute data comprises historical data corresponding to past process values, past process types, or past process providers.

3. The method of claim 1, wherein the store attribute data comprises data corresponding to at least one of a store's transaction volume, operating hours, geographical coordinates, region, population density, parking lot area, city, urbanicity, store format, store market, or whether a first store shares a parking lot with another store.

4. The method of claim 1, wherein the regional climate data comprises statistical data corresponding to rainfall, temperature, snowfall depth, snowfall frequency.

5. The method of claim 1, wherein the graphical user interface further comprises identification information corresponding to a snow removal contractor.

6. The method of claim 1, wherein the graphical user interface further comprises a graphical indication of historical snow removal process values and historical snow removal process types for each of the comparable stores.

7. The method of claim 6, wherein the graphical indications of historical snow removal process values and historical snow removal process types for each of the comparable stores are sorted by proximity to the specific store.

8. The method of claim 1, further comprising receiving, via the graphical user interface, a distance radius value.

9. The method of claim 8, wherein each of the comparable stores is within the distance radius of the specific store.

10. The method of claim 1, wherein the graphical user interface further comprises a graph indicative of the regional climate data, store attribute data, historical snow removal process values, or historical snow removal process types for at least one of the comparable stores.

11. The method of claim 1, further comprising computing, using the store comparison module, a single comparable store having store attribute data and regional climate data most similar to the selected store.

12. A system of controlling a graphical user interface of an electronic display device in response to a computational analysis of attribute data, regional climate data, and historical contract data, the system comprising:
one or more servers programmed to:
receive, in an electronic computer-readable format, store attribute data corresponding to store attributes from a plurality of stores;
receive, in an electronic computer-readable format, regional climate data corresponding to the regional climate of each of the plurality of stores;
receive from a user store identification information identifying a specific store from the plurality of stores; and
receive, in an electronic computer-readable format from one or more servers associated with each of a list of comparable stores, data corresponding to historical snow removal process values and historical snow removal process types for each of the comparable stores;
a store comparison module programmed to:
compute the list of comparable stores from the plurality of stores, each of the comparable stores having store attributes and regional climates similar to the specific store based on a computational analysis of the attribute data and regional climate data;
a process type recommendation module programmed to:
compute a snow removal process type recommendation for the specific store based on a computational analysis of the historical snow removal process types of the comparable stores;
a process value recommendation module programmed to:
compute a snow removal process value recommendation for the specific store based on a computational analysis of the historical snow removal process values of the comparable stores; and
an electronic display device programmed to:
render a graphical user interface, the graphical user interface comprising a graphical indication of the snow removal process type recommendation and the snow removal process value recommendation for the specific store.

13. The system of claim 12, wherein the store attribute data comprises historical data corresponding to past process values, past process types, or past process providers.

14. The system of claim 12, wherein the store attribute data comprises data corresponding to at least one of a store's transaction volume, operating hours, geographical coordinates, region, population density, parking lot area, city, urbanicity, store format, store market, or whether a first store shares a parking lot with another store.

15. The system of claim 12, wherein the regional climate data comprises statistical data corresponding to rainfall, temperature, snowfall depth, snowfall frequency.

16. The system of claim 12, wherein the graphical user interface further comprises identification information corresponding to a snow removal contractor.

17. The system of claim 12, wherein the graphical user interface further comprises a graphical indication of historical snow removal process values and historical snow removal process types for each of the comparable stores.

18. The system of claim 17, wherein the graphical indications of historical snow removal process values and historical snow removal process types for each of the comparable stores are sorted by proximity to the specific store.

19. The system of claim 12, wherein the electronic display device is further programmed to receive, via the graphical user interface, a distance radius value.

20. The system of claim 19, wherein each of the comparable stores is within the distance radius of the specific store.

21. The system of claim 12, wherein the graphical user interface further comprises a graph indicative of the regional climate data, store attribute data, historical snow removal process values, or historical snow removal process types for at least one of the comparable stores.

22. The system of claim 12, wherein the one or more servers is further programmed to compute a single comparable store having store attribute data and regional climate data most similar to the selected store

23. A non-transitory computer readable medium storing instructions executable by a processing device, wherein execution of the instructions causes the processing device to implement a method of controlling a graphical user interface of an electronic display device in response to a computational analysis of attribute data, regional climate data, and historical process data received from one or more external servers, the method comprising:
receiving, in an electronic computer-readable format, store attribute data corresponding to store attributes from a plurality of stores;
receiving, in an electronic computer-readable format, regional climate data corresponding to the regional climate of each of the plurality of stores;
receiving from a user store identification information identifying a specific store from the plurality of stores;
computing, using a store comparison module, a list of comparable stores from the plurality of stores, each of the comparable stores having store attributes and regional climates similar to the specific store based on a computational analysis of the attribute data and regional climate data;
receiving, in an electronic computer-readable format from one or more servers associated with each of the comparable stores, data corresponding to historical snow removal process values and historical snow removal process types for each of the comparable stores;
computing, using a process type recommendation module, a snow removal process type recommendation for the specific store based on a computational analysis of the historical snow removal process types of the comparable stores;
computing, using a process value recommendation module, a snow removal process value recommendation for the specific store based on a computational analysis of the historical snow removal process values of the comparable stores; and
rendering, on an electronic display device, a graphical user interface, the graphical user interface comprising a graphical indication of the snow removal process type recommendation and the snow removal process value recommendation for the specific store.

24. The medium of claim 23, wherein the store attribute data comprises historical data corresponding to past process values, past process types, or past process providers.

25. The medium of claim 23, wherein the store attribute data comprises data corresponding to at least one of a store's transaction volume, operating hours, geographical coordinates, region, population density, parking lot area, city, urbanicity, store format, store market, or whether a first store shares a parking lot with another store.

26. The medium of claim 23, wherein the regional climate data comprises statistical data corresponding to rainfall, temperature, snowfall depth, snowfall frequency.

27. The medium of claim 23, wherein the graphical user interface further comprises identification information corresponding to a snow removal contractor.

28. The medium of claim 23, wherein the graphical user interface further comprises a graphical indication of historical snow removal process values and historical snow removal process types for each of the comparable stores.

29. The medium of claim 28, wherein the graphical indications of historical snow removal process values and historical snow removal process types for each of the comparable stores are sorted by proximity to the specific store.

30. The medium of claim 23, wherein execution of the instructions further causes the processing device to receive, via the graphical user interface, a distance radius value.

31. The medium of claim 30, wherein each of the comparable stores is within the distance radius of the specific store.

32. The medium of claim 23, wherein the graphical user interface further comprises a graph indicative of the regional climate data, store attribute data, historical snow removal process values, or historical snow removal process types for at least one of the comparable stores.

33. The medium of claim 23, wherein execution of the instructions further causes the processing device to compute a single comparable store having store attribute data and regional climate data most similar to the selected store.
